(19) United States
(12) Patent Application Publication
(10) Pub. No.: US 2004/0129063 A1
(43) Pub. Date: Jul. 8, 2004

(54) Method for performing nanoscale dynamics imaging by atomic force microscopy

(76) Inventors: Mehdi Balooch, Berkeley, CA (US); Kambiz Farnaam, Danville, CA (US)

Correspondence Address: Ali Kamarei, Esq., Inhouse IP Counsel, 280 Colorado Avenue, Palo Alto, CA, 94301, US

(21) Appl. No.: 10/336,397

(22) Filed: Jan. 3, 2003

(51) Int. Cl. G01B 5/28

(52) U.S. Cl. 73/105

(57) ABSTRACT

Mechanical properties (e.g. storage modulus and loss modulus), nanoscale dynamics (dynamic behavior of a material in the nanoscale) and structural properties (crystallographic orientation) imaging of material, ranging from biological to electronic materials are obtained by modification of conventional atomic force microscopy. The device and method allows for simultaneous topography and properties (mechanical, nanoscale dynamics, and structural) imaging both in liquid and dry conditions.

### BACKGROUND

For the past 10 years, scanned probe microscopy (atomic force microscopy (AFM)) has been used to investigate surfaces and adsorbates on surfaces with near atomic resolution (nanoscale). In AFM, a laser beam striking the backside of a cantilever is reflected into a photo detector that is divided into two or four segments. As the cantilever starts to “feel” the surface (in the “contact” imaging mode), it slightly bends. The “bend” of the cantilever is therefore detected by the scattering of the laser light from the back of the cantilever into different areas of the segmented photo-detector. The difference between the amounts of light collected by different segments is related to the degree of the bending of the cantilever and can be used in a feedback system to obtain the topographic image.

Currently, there are two basic methods for imaging by AFM: contact and non-contact (tapping). In contact mode, the tip at the end of a cantilever is touching the surface and acts as a profilometer. In tapping mode, the tip is vibrating at a single frequency (close to the resonance frequency of the cantilever) above the surface. As the tip approaches the surface, the amplitude and phase of vibration change due to interaction with the surface. Either of these parameters can be used as a feedback for topographic imaging. Due to the design of the tip and its cantilever it is not possible to achieve a large amplitude of movement for the tip in a range of frequencies, except close to resonance frequency of the cantilever. In fact the tip only allows a large enough amplitude of movement at its resonance frequency to be detected. The resonance frequency of the tip/cantilever is obtained by scanning the frequency using a Piezo stacks behind the cantilever holder. This resonance frequency is a function of the design of the tip and the cantilever, and the material they are made of. The phase value obtained in this single frequency method is only used for control purposes, and is not used to provide any valuable information regarding the material dynamics of the near surface regions. Moreover, the tapping mode performs the same function as the contact mode except with lower applied force to the sample, but at the expense of a lower resolution.

Recently, Hysitron Inc. replaced the tip assembly by a transducer for simultaneous topography and local mechanical properties measurements. In the imaging mode, the displacement of the transducer is used for feedback purposes. For mechanical properties measurement the tip displacement and calculated force resultant from the electrostatic charge applied between moving and static plates of the transducer are utilized. More recently Collton et.al S. A. Syed Asif, K. J. Wahl, R. J. Colton, and O. L. Warren. Quantitative imaging of nanoscale mechanical properties using hybrid nanoindentation and force modulation. J. Appl. Phys. 90, 1192 (2001), and 2. S. A. Syed Asif, K. J. Wahl, R. J. Colton, and O. L. Warren, J. Appl. Phys. 90, 5838 (2001) used a modulation technique for stiffness imaging. The disadvantage of using such a transducer assembly is its large mass and its high stiffness. As a result, the minimum force applicable for imaging using this technique is orders of magnitude higher than conventional AFM, which makes it unsuitable for materials softer than metals and ceramics such as encountered in biomaterial applications.

Another disadvantage of the current system is the larger radius of the curvature of this tip (made of diamond) compared to conventional Si or Si₃N₄ AFM tips, thus, the inability of the present system to perform nanoscale characterization, in addition to its huge price difference. In addition, the assembly can be modulated at only low frequencies (=200 Hz), therefore a long time (in the order of an hour) is required for stiffness imaging. Piezo drift during this time is substantial especially for biomaterial applications. Moreover a complete new set of hardware and software is required to run the system, which make the combined (AFM and indentation) system expensive. Finally the present system is not suitable for measurements in liquids since the meniscus force applied to the tip is usually higher than the force required for mechanical properties measurements.

The term “Nanoscale Dynamics” relates to dynamic behavior of a material in the nanoscale in contrast to its static behavior. Typical visco-elastic mechanical characterization of a material is performed under static conditions with the purpose of determining the storage modulus and the loss modulus of the material, by applying a simple linear Voigt model consisting of a spring and a dashpot in parallel. In doing so, the detailed time related behavior of the material (i.e. its dynamics) is ignored. In addition, non-linear behavior of a material with respect to imposed forces as intertwined with its dynamic behavior cannot be derived from the current state of the art in AFM technology. Dynamics behavior of a material in the near surface region (i.e. nanoscale dynamics) is extremely important in understanding and estimating phenomena such as surface-surface interactions, self diffusion (creep), inter-diffusion, and so on.

Therefore there is a strong need for a simple method to nondestructively and simultaneously investigate mechanical, dynamics, and structural mapping of near surface of a material using conventional atomic force microscopy (AFM). Nondestructively is defined as there being no change in the structure of the sample, after the sample's properties are investigated or an image of the sample is taken.

There is a further need for a method to investigate near surface, and stiffness and elastic modulus imaging simultaneously with an AFM, nondestructively.

There is also a need for a method for non-contact topography imaging simultaneous with mechanical properties imaging, nondestructively.

Yet another need is for a method for topography, stiffness and elastic modulus imaging of soft materials, such as living biological tissue, in wet (liquid) or dry conditions, without destruction of the tissue.

Another need is for a device to provide mechanical properties mapping in the liquid phase nondestructively.

There is a need for a device to map the mechanical properties of samples at different temperatures, nondestructively There is another need for a device to map the dynamics behavior of the surface materials, nondestructively.

Finally, there is a need for a device that can measure the structural properties of surfaces, nondestructively.

### SUMMARY

It is an objective of the present invention to provide a simple method to simultaneously and nondestructively investigate mechanical, nanoscale dynamics, and structural mapping of near surface of a material using conventional atomic force microscopy (AFM).

It is an objective of the present invention to provide a simple method to investigate near surface, and stiffness and elastic modulus imaging simultaneously and nondestructively with an AFM.

Another objective of the invention is to provide a method for non-contact topography imaging simultaneous with mechanical properties imaging.

A further objective of the invention is to provide a method for topography, stiffness and elastic modulus imaging of soft materials, such as living biological tissue, in wet (liquid) or dry conditions, without destruction of the tissue.

Another objective of the invention is to provide mechanical properties mapping in the liquid phase.

Another objective of the invention is to map the mechanical properties of samples at different temperatures.

Another objective of the invention is to map nanoscale dynamics of surface materials.

Another objective of the invention is to map the structural properties of surfaces

### BRIEF DESCRIPTION OF THE DRAWINGS

The accompanying drawings, which are incorporated into and form a part of the disclosure, illustrate embodiments of the invention and together with the description, serve to explain the principles of the invention.

FIG. 1 schematically illustrates the principle components of the tip assembly to be used for topographic (in contact mode) and mechanical properties imaging in dry environments.

FIG. 2 illustrates the principle components of the tip assembly to be used for liquid environments.

FIG. 3 shows a top and side view of the diamond tip, cantilever, and cantilever holder, all integrated into a single unit having an integrated circuit design.

FIG. 4 demonstrates the operation of the integrated tip holder in a liquid condition.

FIG. 5 shows the principle of the operation in the stiffness imaging mode (illustrated here using Piezo-electric crystals as drivers).

FIG. 6 shows an alternative embodiment of the invention where the sample is modulated horizontally.

FIG. 7 shows an integrated design for horizontal and vertical modulation of the tip.

FIG. 8 shows a method modeled as force applied to a mass that is attached to two otherwise fixed Voigt elements as long as machine compliance is ignored.

FIG. 9 shows the frequency of modulation?? the amplitude of force modulation Fₑ, the amplitude of DC force F₀, and the temperature T, are varied as controlled variables. The resultant phase, f, and amplitude,?, (with respect to DC displacement) of displacement is then measured and shown.

FIG. 10 shows a typical topographic image of a calcium phosphate/glass composite.

FIG. 11 shows the storage moduli of a calcium phosphate/glass composite.

FIG. 12 shows the loss moduli of the calcium phosphate/glass composite.

FIG. 13 shows the storage modulus map of phosphoprotein deposited on the glass-ceramic composite presented in FIG. 10.

### DETAILED DESCRIPTION

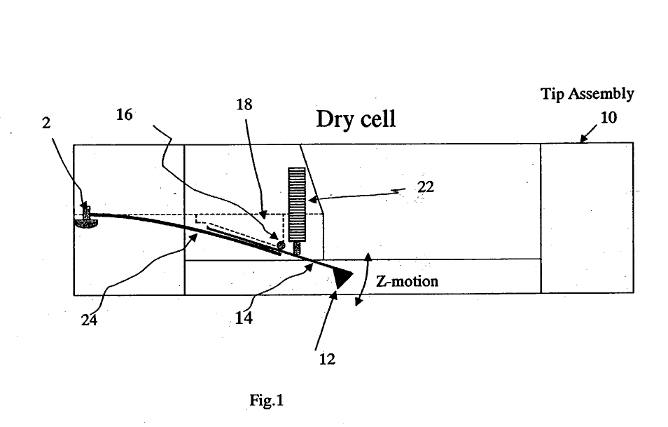

Mechanical properties (e.g. storage modulus and loss modulus), nanoscale dynamics (time-dependent and non-linear behavior), and structural properties (crystallographic orientation) imaging of material, ranging from biological to electronic materials are obtained by modification of conventional atomic force microscopy. FIG. 1 shows the device of the tip assembly 10 as constructed for dry conditions, which comprises of a tip 12 typically having a rounded apex (not shown), preferably made from diamond in this embodiment, assembled on leaf 14 that is pivoted around on pivot point 16 at the end of a ramped support 18. In contact mode, which is more fully described below, the diamond tip rotates around the pivot point 16 as it scans over the surface of sample 20. The modulation frequency is adjustable and can be varied for different scans. In non-contact mode, the tip is modulated with a Piezo-electric tube or Piezo-electric stacks 22 above the surface of the sample at or near resonance frequency to obtain highest amplitude possible. This mode is used for topographic imaging only.

The leaf 14 is preferably comprised of stainless steel and can be integral to and one with cantilever holder 24.

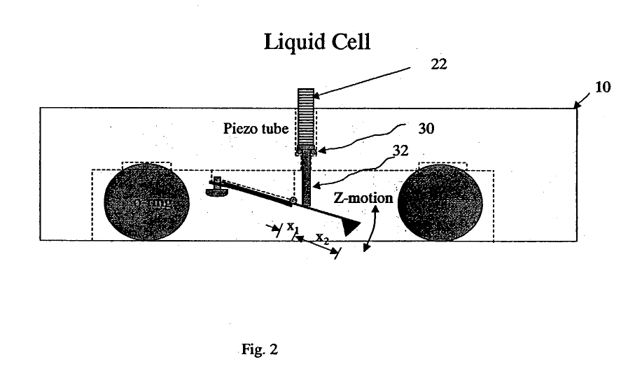

FIG. 2 shows the tip assembly 10 as constructed for liquid (wet) conditions, such as those holding a live biological material. The holder of the liquid is made of transparent materials, such as clear plastic or glass, for laser beam transmission. Preferably, at least one O-ring 30 (shown in cross section) is added to the Piezo-electric tube or Piezo-electric stacks to avoid leakage of liquid into the Piezo electric tube or stacks. In this configuration the tip, the stainless steel leaf and the sample are all immersed in liquid.

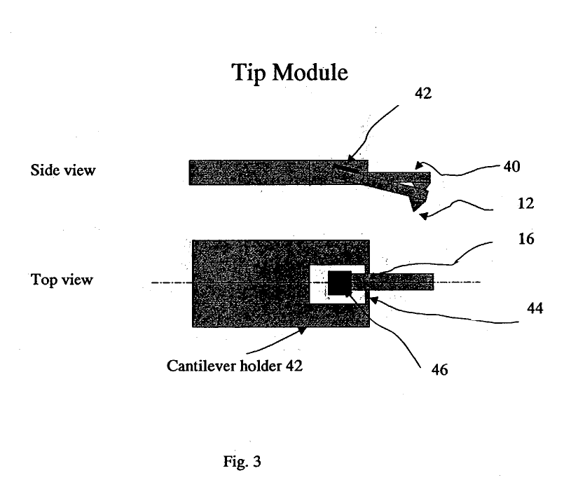

FIG. 3 shows an alternative embodiment where the tip 12, cantilever 40 and cantilever holder 42 are integrated into a single unit using an integrated circuit design. The material of the cantilever in this embodiment is preferably made of Si, Si₃N₄ or SiC, for example. Here the cantilever 40 is attached to torsion support 44 such that it can easily be rotated around the pivot point 16, but not be rotated/twisted around its axis. In addition, the far end of the cantilever 46 is preferably coated with magnetic materials such as Chromium or Cobalt, Cr/Co.

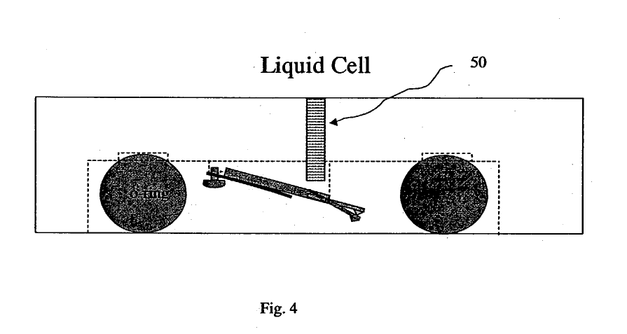

FIG. 4 shows the operation of the embodiment in FIG. 3. The magnetic coil 50 is optionally used to modulate or drive the cantilever and the tip. This embodiment is used to obtain a “static” force-displacement curve for site-specific elastic modulus and hardness determination since the applied force and displacement is optionally obtained.

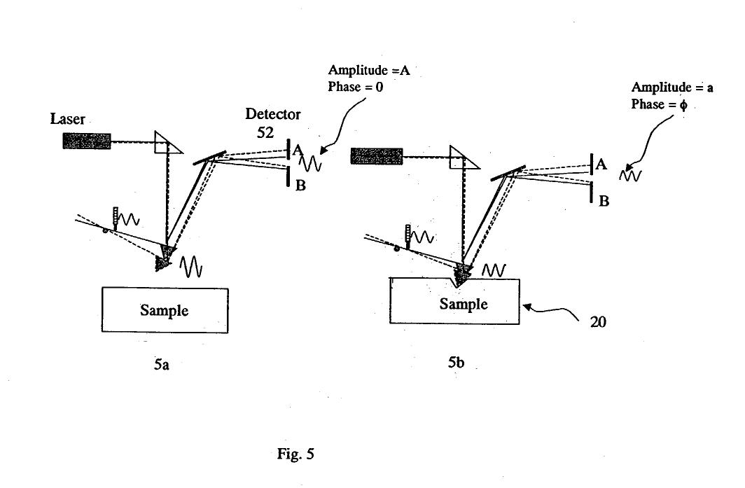

FIG. 5a shows the cantilever is modulated above the surface of the sample using a Piezo-electric tube, or Piezo-electric stacks or a magnetic coil. FIG. 5b shows the cantilever is modulated at the surface of the sample using a Piezo-electric tube, or Piezo-electric stacks 22 or a magnetic coil 50. The detector 52 determines the amplitude of the vibration of the tip and its phase with respect to the AC (Alternative Current) driving force signal (voltage). Thereafter, the amplitude and phase values measured above the surface of the sample are compared to the same parameters at the surface of the sample. The comparison values are used to calculate the mechanical properties of the sample, including the sample's elastic modulus, and its nanoscale dynamics.

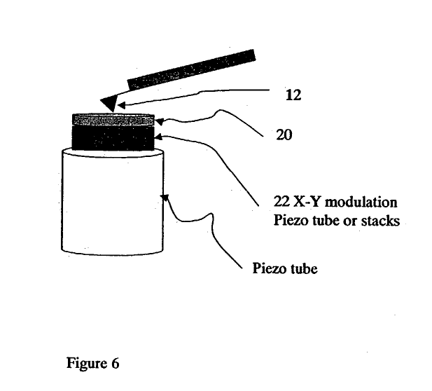

FIG. 6 shows an alternative embodiment of the invention where the sample is modulated horizontally using a Piezo-electric tube, or Piezo-electric stacks 22 as the tip 12 penetrates into the surface of the sample 20. This configuration allows determination of the nanoscale dynamics in the plane (X and Y directions) of the surface to be compared with the normal-to-surface (Z direction) properties for determining anisotropy amongst other information.

The modified tip assembly and method allows simultaneous topography and properties (mechanical, nanoscale dynamics, and structural) imaging both in liquid and dry conditions. A stiff cantilever is pivoted along its length, modulated at one end by a Piezo-electric tube or Piezo-electric stacks or a magnetic coil (driving mechanisms) and has a tip at the other end. The magnitude of electrical or magnetic force is preselected. As a result the amplitude of vibration of the tip about the pivot is precisely determined. Therefore, the photo-detector of AFM is 10 calibrated accordingly. As the tip contacts the sample, the amplitude and the phase of tip displacement into the material are recorded. These two parameters are then used to calculate the stiffness of the materials and by assuming Hertzian mechanics the storage and loss moduli are determined. Nanoscale dynamics studies is implemented by varying the magnitude of the driving force, its modulation frequency and temperature of the surface individually and recording the images of displacement amplitude and its phase with respect to force, frequency, and temperature. Analyzing the derived data results in the nanoscale dynamics and structural mapping in addition to mechanical mapping. In addition to normal modulation, the tip or the sample can also be modulated horizontally as the tip is penetrated into the sample. The horizontal displacement amplitude and its phase lag provide information on horizontal orientation dependence properties (in anisotropic materials for example).

Two kinds of tip assembly are optionally and alternatively used for simultaneous topographic and mechanical properties imaging for contact and non-contact mode of the operations related to topographic component of the invention.

Contact Mode

In contact mode a stiff cantilever is used with a large length (x1+x2 in FIG. 2) to reduce the force applied to the sample for topographic imaging. Optionally, the cantilever is vibrated with a Piezo tube at a distance x1 from the tip making the cantilever rotate at a pivot point, to obtain the dynamic properties of the sample. Making x1 small will avoid bending the cantilever and therefore the displacement into sample can be easily calculated from the expansion and contraction of the Piezo tube. For liquid application the whole tip assembly is enclosed into a transparent tip holder to avoid a meniscus effect and Piezo tube is protected from liquid exposure by an o-ring shown in the FIG. 2.

Non-Contact Mode

In non-contact mode an integrated tip assembly can be used (for example made of Si or SiC) as shown in FIG. 3. Here the cantilever can be rotated around the twisting support at its natural frequency. This can be used for non-contact topographic imaging. For mechanical properties imaging, the Piezo tube contacts the end of the cantilever opposing to tip side and therefore the tip will be forced driven into the sample at a frequency set by the user.

The basic operation of the mechanical, nanoscale dynamics, and structural properties imaging is shown in FIGS. 5 and 6. The tip scans over the sample with feedback on (contact or non-contact modes). Then the feed back is turned off and tip is scanned over in interleave mode, as readily known in conventional AFM imaging. This time the tip is modulated with frequency f. The amplitude and phase with respect to amplitude and phase when the sample is far away from the tip, are recorded. These parameters are then used to calculate the stiffness and damping of the sample. Finally stiffness and damping are used to calculate the storage and loss moduli assuming Hertzian contact mechanics pixel-by-pixel.

The above-mentioned procedure is then repeated for different frequency and magnitude of the force and different temperature of the surface. The measured phase and amplitude values are used to obtain the nanoscale dynamics and structural properties map.

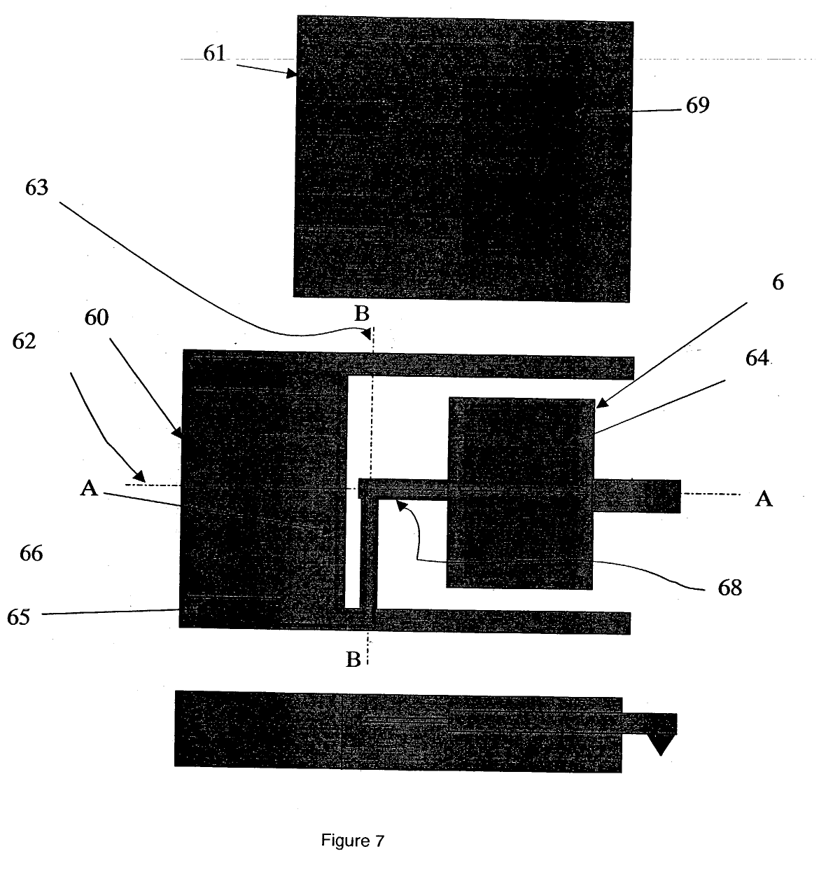

The tip is optionally penetrated into the near surface of the material under investigation with controlled varying frequency, force amplitude and sample temperature as “input variables”. Near surface is defined as the few monolayers close to the surface of the sample. The number of monolayers in the “Near Surface” is sample dependent, i.e. depends on the chemical structure and mechanical structure of the sample. Various samples may have different number of monolayers in their “Near Surface”, for example water's “Near Surface” may have up to 5 monolayers. Another integrated design for horizontal and vertical modulation is shown in FIG. 7. The tip assembly consists of two parts, 60 and 61 that are attached together by some means such as glue. A stiff cantilever, having the tip in one end, is attached at the other end to a square shaped plate, 67, that is coated with two separate squares of conductive films, 64. The other end of the plate is attached to another stiff “L” shaped cantilever, 68. The top part, 61, is also coated with two separate squares of conductive films 69 (matching the location of the squares on part 67 when parts 61 and 67 are laid facing each other). Application of a voltage potential between the palates after the two parts are glued together will result in bending (when applying same alternating voltage to both squares) and twisting (when applying 1800 apart AC voltages to the squares) of the cantilever for generating horizontal and/or vertical modulation of the tip into the sample.

The new device and method described as the invention herein requires minimal modification of existing AFM assemblies. The tip is penetrated into the near surface (the few monolayers close to the surface) of the material under investigation with controlled-varying frequency, force amplitude and sample temperature as “input variables”. The resulting displacement of the tip into the sample and its phase lag with respect to force modulation are recorded as “output parameters” as the tip scans the surface. These parameters are used to obtain the local nanoscale dynamics (time related behavior), mechanical properties (storage and loss moduli), and structural properties (crystallographic orientation) of materials near the surface. As a result, mechanical, dynamics and structural mapping of the near surface can be recorded with near atomic scale (nanoscale) spatial resolution as shown by the following examples.

### EXAMPLES

### Example 1

### Calculation of Elastic Moduli for a Simple Linear Viscoelastic

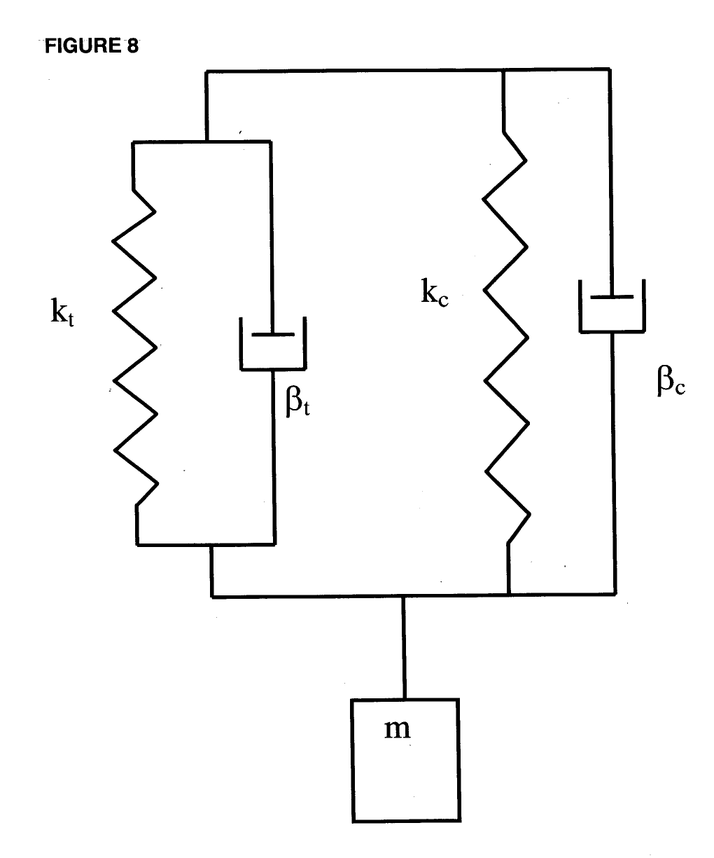

The method is modeled as force applied to a mass that is attached to two otherwise fixed Voigt elements shown in FIG. 8 as long as machine compliance is ignored.

The Voigt element kₜ βₜ represents stiffness and damping of the lip module and k_{c} β_{c} represents the same quantities for the contact to the sample. The relevant equation of motion is

Fₑ(t)=Fₒ sin(ωt)=m(dz²/dt²)+β(dz/dt)+kz

where Fₒ is the amplitude of the applied sinusoidal force, m is the moving mass of the module, β=βₜ+β_{c} is the combined damping coefficient of tip module and contact, k=kₜ+k_{c} is the combined stiffness of tip module and contact, z is the resulting sinusoidal displacement, and t represents time. The solution to this differential equation is well known as

z=zₒ sin(ωt+φ)

where the displacement amplitude, zₒ, is given by the dynamic compliance function

zₒ/Fₒ=1/[(k−mω²)²+(βω)²]^{1/2}

and the phase φ of the displacement is dictated by

tan(φ)=−βω/(k−mω²)

Inspection of the solution to the relevant equation of motion reveals that the dynamics of the tip module is characterized to make the extraction of the sample's material properties possible. Furthermore, electronic filters affecting electrostatic or magnetic force application and displacement detection is taken into consideration. The software method automatically scales applied voltages to compensate for filters that ultimately affect electrostatic or magnetic force, and make post-acquisition corrections to amplitude and phase by accounting for the electronic transfer function of the displacement detection channel. Determination of m, βₜ and kₜ is accomplished by non-linear curve fitting of the dynamic compliance vs. frequency trace obtained in air.

When operating in the mode of force modulation imaging, the nominal contact force is determined solely by the tip deflection about the pivot and is maintained at a constant value (e.g. in the nano Newton range for soft materials) by the imaging feedback controller such as in interleave mode. The displacement of the Piezo tube or stacks is calibrated with respect to the applied voltage and calibrated force at the on set of the experiment. The amplitude of the modulated displacement is large enough to maintain good signal-to-noise ratio for all material phases of the sample but sufficiently small to prevent destruction of the sample. Nominal contact force, displacement amplitude, displacement phase, and topography are signals available for recording at each of the 512×512 pixels of the imaging process. The AFM instrument used in this study supports simultaneous acquisition of three signal channels: topography, displacement amplitude and phase with respect to applied force.

The storage and loss components of the complex contact stiffness, as is defined in the art of solid mechanics, are extracted from the spatially correlated set of amplitude and phase images to generate quantitative stiffness maps.

K′=k_{c}

K″=β_{c}ω

Converting this data to quantitative modulus maps requires knowledge of the contact radius at each pixel. It is assumed that the nominal contact force is sufficiently low to justify the use of Hertzian theory, K. L. Johnson, Contact Mechanics (Cambridge: University Press, 1985), for contacts involving only the rounded apex of the tip. Rearrangement of the familiar equations of Hertzian theory yields the following relationship for the contact radius (a):

a=(3FR/2K′)^{1/2}

where F corresponds to the nominal contact force, and R is the tip radius which is about 20 nm for tips used in this example. The local storage modulus is then formulated as

E′=½K′/a

and the loss component as

E″=½K″/a

This method of accounting for the contact radius does not require knowledge of tip penetration, and thus is immune from thermal drift of the Piezo.

### Example 2

### Elastic Moduli for a Non-Linear Viscoelastic

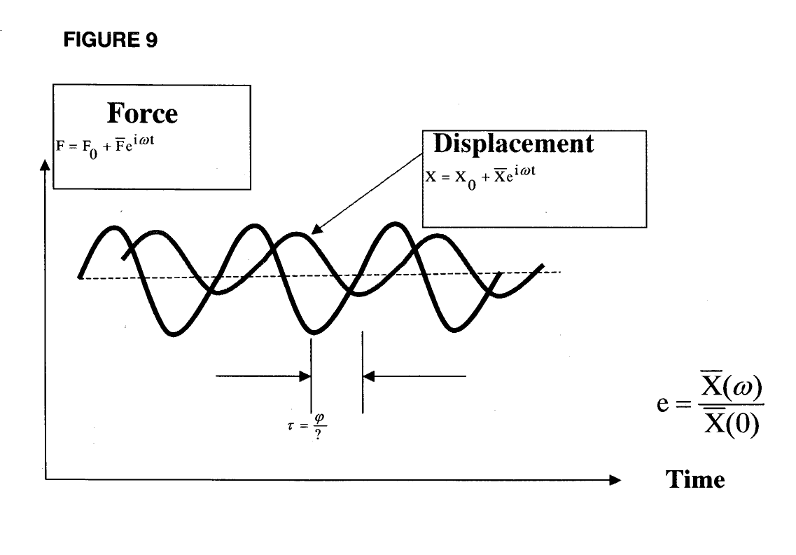

For nonlinear-materials such as soft polymers and biomaterials, the simple linear model exhibited in example 1 cannot explain the behavior of the materials. To obtain the detailed mechanical properties of materials, the frequency of modulation?? the amplitude of force modulation Fₑ, the amplitude of DC force F₀, and the temperature T, are varied as controlled variables. The resultant phase, f, and amplitude,?, (with respect to DC displacement of displacement is then measured. From these two parameters, the detailed mechanical properties are then modeled. These variables are shown in FIG. 9.

### Example 3

### Elastic Moduli for Glass-Ceramic Composite

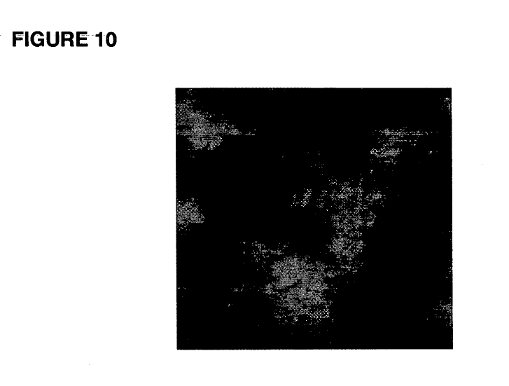

The photograph in FIG. 10 is a typical topographic image of a calcium phosphate/glass composite.

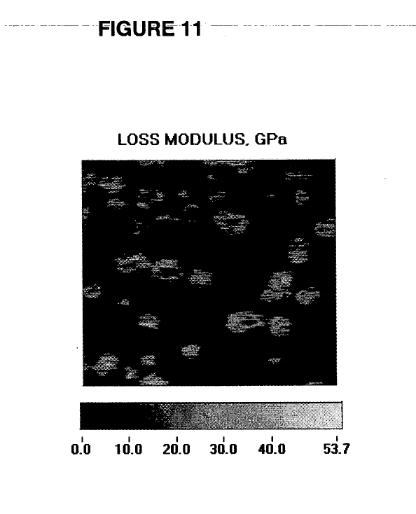

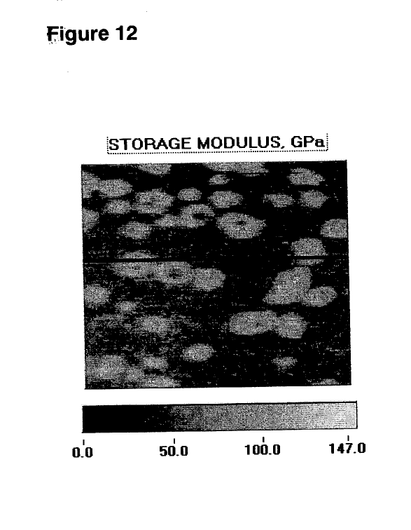

The storage and loss moduli of this sample are shown in FIG. 11 and FIG. 12, respectively. The gray scale is proportional to the values of moduli.

### Example 4

### Elastic Modulus of Protein on a Glass-Ceramic Composite

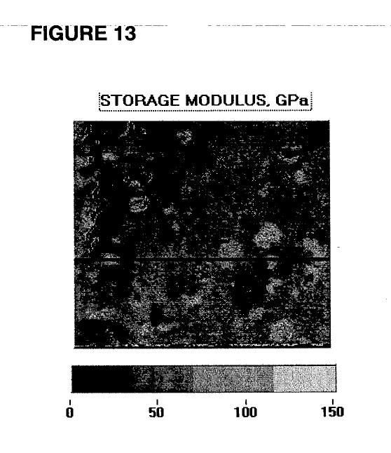

FIG. 13 shows the storage modulus map of phosphoprotein deposited on the glass-ceramic composite presented on example 3. The dark areas are associated with the protein. Storage modulus of phosphoprotein aggregates on glass composite substrate.

From the aforementioned description, it is appreciated how the objectives and features of the above-described invention are met. First, the present invention provides a simple method to nondestructively and simultaneously investigate mechanical, nanoscale dynamics and structural mapping of near surface of a material using conventional atomic force microscopy (AFM).

Second, the present invention to provide a simple method to investigate near surface, stiffness, and elastic modulus imaging simultaneously with an AFM.

Third, the invention provides a method for non-contact topography imaging simultaneous with mechanical properties imaging.

Fourth, the invention provides a method for topography, stiffness and elastic modulus imaging of soft materials, such as living biological tissue, in wet (liquid) or dry conditions, without destruction of the tissue.

Fifth, the invention provides mechanical properties mapping in the liquid phase.

Sixth, the invention maps the mechanical properties of samples at different temperatures.

This invention has been described with respect to a nanoscale dynamics. However, it is appreciated that various modifications of the apparatus and method are possible without departing from the invention, which is defined by the claims set forth below.

What is claimed is:

1. A scanned probe microscope device having an improved tip assembly arranged for measuring mechanical, nanoscale dynamics and structural mapping of the near surface of a sample, the tip assembly comprising:
a. a tip module,
b. a driving mechanism, and
c. a tip that produces a detectable displacement signal at a spectrum of frequencies.

2. The device of claim 1 wherein the tip module is further comprised of a cantilever and a cantilever holder.

3. The device of claim 1 wherein the driving mechanism is selected from the group comprising of Piezo electric tube, Piezo electric stacks, and magnetic coils.

4. The device of claim 2 wherein the cantilever has a tip at one end and connected to a cantilever holder at the other end, the cantilever pivoted along its length.

5. The device of claim 1 wherein the viscoelastic properties of the near surface of the sample is calculated.

6. The device of claim 1 wherein the driving mechanism is a modulating force.

7. The device of claim 1 wherein the tip modulates at a spectrum of frequencies.

8. The device of claim 7 wherein the nanoscale dynamics and structural properties of the near surface of the sample is calculated.

9. The device of claim 7 wherein the spectrum of frequencies is between zero and 1 mega hertz.

10. The device of claim 1 wherein the sample and tip assembly are in liquid.

11. The device of claim 1 wherein the sample and tip assembly are in vacuum.

12. The device of claim 1 wherein the driving mechanism produces an electrical or magnetic force.

13. The device of claim 12 wherein the magnitude of electrical or magnetic force is preselected.

14. The device of claim 1 wherein the displacement of the tip into the sample is measured over time.

15. The device of claim 1 wherein the sample is biological material.

16. The device of claim 15 wherein the biological material is living.

17. The device of claim 15 wherein the biological material is in vitro.

18. The device of claim 1 wherein the tip is selected from the group comprising of diamond, tungsten, silicon, silicon nitrite, and silicon carbide.

19. The device of claim 1 wherein the near surface of the sample is heated.

20. The device of claim 19 wherein the near surface of the sample is heated by radiation, convection or conduction.

21. The device of claim 1 wherein the tip is stationary at one pixel.

22. The device of claim 1 wherein the tip is movable across the surface of the sample.

23. The device of claim 22, wherein the tip is movable in a line of pixels.

24. The device of claim 22 wherein the tip is movable in an area array of pixels.

25. A method of determining the nanoscale dynamics and structural mapping of a near surface of a sample by modulating a tip penetrated into the sample the method comprising:
a. displacement of a tip into the sample as a result of displacement of tip or the sample, using electrical or magnetic force,
b. calculating the properties of the sample using the amount of electrical-or magnetic force and any displacement of the tip into they sample, and
c. detecting the displacement signal of the tip at a spectrum of frequencies.

26. The device of claim 25 wherein the viscoelastic properties of the near surface of the sample is calculated.

27. The device of claim 25 wherein the electrical or magnetic force is a modulating force.

28. The device of claim 25 wherein the tip modulates at a spectrum of frequencies.

29. The device of claim 28 wherein the nanoscale dynamics and structural properties of the near surface of the sample is calculated.

30. The device of claim 28 wherein the spectrum of frequencies is between zero and 1 mega hertz.

31. The device of claim 25 wherein the sample and tip assembly are in liquid.

32. The device of claim 25 wherein the sample and tip assembly are in vacuum.

33. The device of claim 25 wherein the magnitude of electrical or magnetic force is preselected.

34. The device of claim 25 wherein the length of displacement of the tip into the sample is measured over time.

35. The device of claim 25 wherein the sample is biological material.

36. The device of claim 35 wherein the biological material is living.

37. The device of claim 35 wherein the biological material is in vitro.

38. The device of claim 25 wherein the tip is selected from the group comprising of diamond, tungsten, silicon, silicon nitrite, and silicon carbide.

39. The device of claim 25 wherein the electrical force is delivered via Piezo-electric tube or Piezo-electric stacks.

40. The device of claim 25 wherein the magnetic force is delivered using a magnetic coil.

41. The device of claim 25 wherein the near surface of the sample is heated.

42. The device of claim 41 wherein the near surface of the sample is heated by radiation, convection or conduction.

43. The device of claim 25 wherein the tip is stationary at one point.

44. The device of claim 25 wherein the tip is movable across the surface of the sample.

45. The device of claim 44, wherein the tip is movable in a line of pixels.

46. The device of claim 44 wherein the tip is movable in an area array of pixels.

47. The method of claim 25 further comprising input signals selected from the group comprising of force of tip applied to the sample, frequency of modulation of the tip, and temperature of the sample.

48. The method of claim 47 further comprising output measured signals selected from the group comprising of displacement amplitude of the tip and its phase.

49. The method of claim 48 wherein the input signal and output measured signals are used to calculate the nanoscale dynamics and structural mapping of the smaple.
